(19) United States
(12) Patent Application Publication
(10) Pub. No.: US 2005/0223588 A1
(43) Pub. Date: Oct. 13, 2005

(54) Apparatus and method for drying substrates

(76) Inventor: Eric Hansen, Boise, ID (US)

Correspondence Address: STALLMAN & POLLOCK LLP, SUITE 2200, 353 SACRAMENTO STREET, SAN FRANCISCO, CA, 94111, US

(21) Appl. No.: 11/066,864

(22) Filed: Feb. 25, 2005

Related U.S. Application Data
(60) Provisional application No. 60/548,468, filed on Feb. 27, 2004.

(51) Int. Cl. B08B 3/12; F26B 3/00; F26B 19/00

(52) U.S. Cl. 34/351; 134/1; 34/201

(57) ABSTRACT

The present application describes a system for drying substrates which includes a chamber and an inner vessel having an upper edge positioned within the chamber. Process fluid is directed into the inner vessel and allowed to cascade over the upper edge. The upper edge of the inner vessel is lowered to thereby lower the cascade level across the surface of the substrate, while a drying vapor is introduced into the chamber. As the cascade level descends across the surface of the substrate, the substrate surface is exposed to the drying vapor. Megasonic energy may be directed into the inner vessel to accelerate drying using boundary layer thinning.

### PRIORITY

This application claims the benefit of U.S. Provisional Application No. 60/548,468, filed Feb. 27, 2004.

### FIELD OF THE INVENTION

The present invention relates generally to the field of apparatuses and methods for drying substrates requiring a high level of cleanliness.

### BACKGROUND OF THE INVENTION

In certain industries there are processes that must be used to bring objects to an extraordinarily high level of cleanliness. For example semiconductor substrates are cleaned, rinsed and dried at multiple stages during the fabrication of integrated circuits to remove chemicals, residues and particles from the substrates. Integrated circuit fabrication technology has advanced to a point where fine features can be as small as 90 nm and smaller in size. As device size decreases, the level of cleanliness required in the fabrication process increases. With 90 nm feature sizes, even watermarks left behind during cleaning and drying of the substrates can lead to so-called “killer defects” in the integrated circuit devices. The present application describes a new, highly effective system and method for cleaning substrates oriented towards minimizing deposition of particles and watermarks on the substrates.

### BRIEF DESCRIPTION OF THE DRAWINGS

FIGS. 1A through 1C are a sequence of drawings schematically illustrating use of a system and method for drying substrates.

FIG. 2A is a cross-sectional end view illustrating an alternative inner vessel for use with the system of FIGS. 1A through 1C.

FIG. 2B is a cross-sectional end view illustrating a second alternative inner vessel for use with the system of FIGS. 1A through 1C.

FIG. 3 schematically illustrates Marangoni flow from a wafer surface.

### DETAILED DESCRIPTION OF THE DRAWINGS

Structure

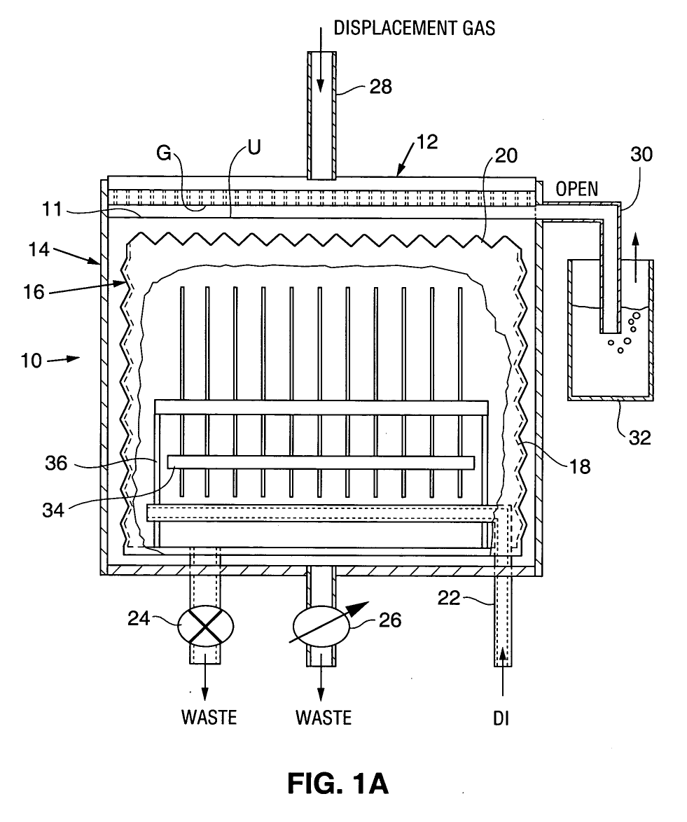

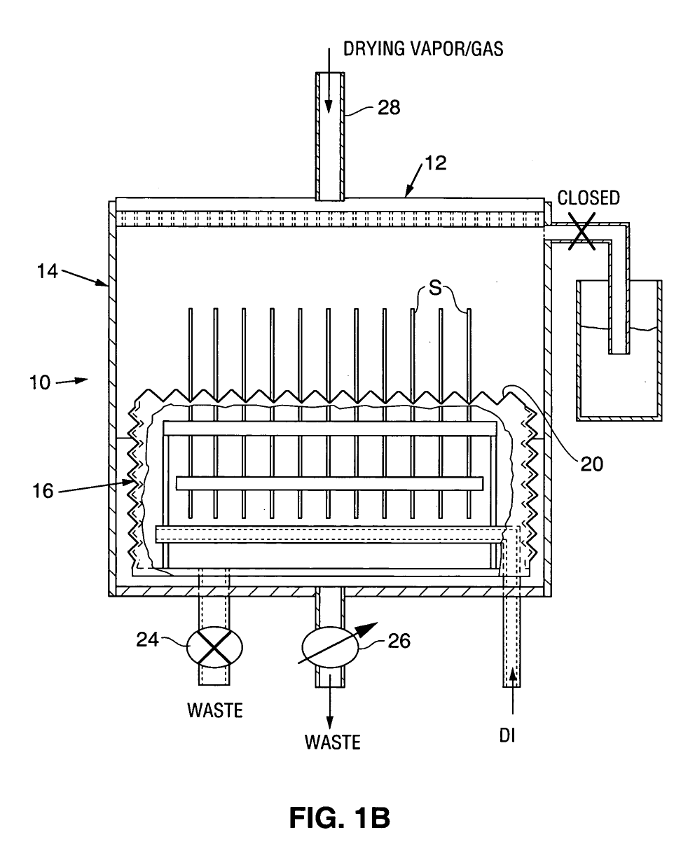

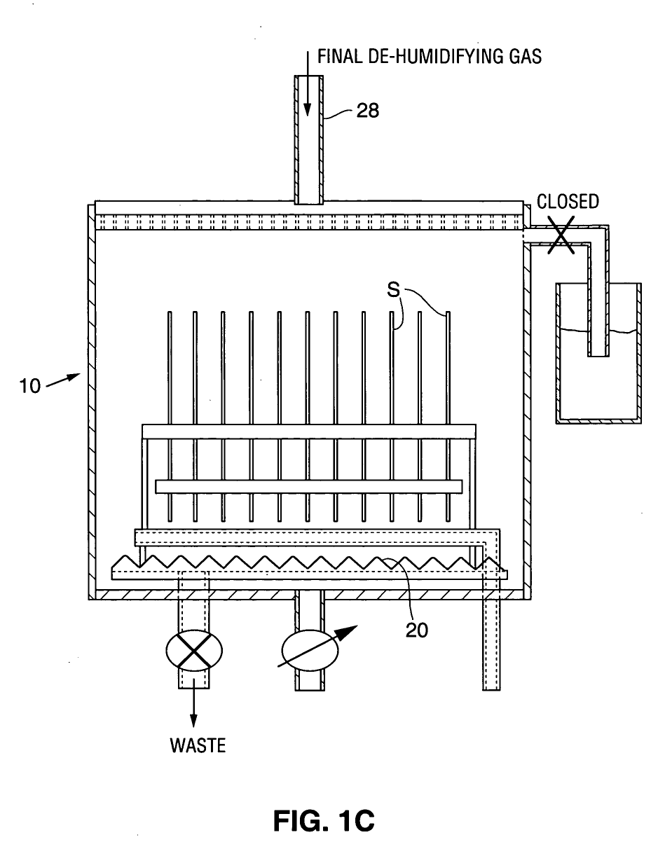

Referring to FIG. 1A, a drying system includes a chamber 10 having an opening 11, and a lid 12 moveable into place to cover the opening 11. Chamber 10 has an outer vessel 14 and an inner vessel 16 disposed within the outer vessel 14.

The outer vessel is formed of a material such as PVDF or Teflon™ that is inert to chemicals used in the process environment.

Inner vessel 16 includes sidewalls 18 having upper edges 20. Although FIGS. 1A through 1C illustrate a batch system in which the inner vessel 16 is proportioned for simultaneous processing of multiple substrates S, the inner vessel may instead by proportioned for single substrate processing or for processing only two substrates at one time. Component arrangements for single- and double-substrate wet processing systems are shown and described in WO03050861 APPARATUS AND METHOD FOR SINGLE- OR DOUBLE-SUBSTRATE PROCESSING, which is incorporated herein by reference. Moreover, a vessel proportioned for single-substrate wet processing and associated automation is the EMERSION 300(tm) Single Wafer Processor manufactured by SCP Global Technologies, Boise, Id.

As will be described in detail below, the upper edge and walls of the inner vessel 16 function as an overflow weir, such that fluid introduced into the inner vessel 16 overflows the walls of inner vessel 16 into the outer vessel 14. The inner vessel's upper edges 20 are preferably serrated as shown to minimize fluid accumulation on the edges.

The system is further configured such that the elevation of the upper edges 20 (and thus the cascade level of fluid cascading through the inner vessel 16) relative to the elevation of the wafer substrate can be raised or lowered during use of the system. In the FIG. 1A-1C embodiment, this is achieved by providing sidewalls 18 to be collapsible within the chamber 10. By collapsing the sidewalls 18, the upper edges 20 may be moved between an upper position shown in FIG. 1A, and a lower position shown in FIG. 1C. In one embodiment, the collapsible sidewalls may fold “accordion” style as illustrated in FIG. 1B. The inner vessel 16 may be made of PTFE or other material inert to chemicals used in the process environment and also capable of collapsing and expanding over many cycles without fatigue. The inner vessel includes a drive system (not shown) including a motor and associated components positioned outside the outer vessel and coupled to the inner vessel via a linkage. It is desirable to prevent air from passing into the chamber 10, since gases, fumes, and particles from the external environment can diffuse into rinse fluid in the chamber 10. Diffusion of oxygen into the chamber head space and rinse bath fluid can lead to undesirable watermarks on the substrates. Thus, the linkage preferably passes through a fluid interlock (similar to a p-trap used in plumbing) to prevent outside air from passing along the linkage into the chamber 10. Alternative configurations may also be used to permit movement or positioning of the cascade elevation relative to the surface of the substrate(s). For example, in one alternative embodiment, inner vessel 16 may instead retain its volume but be moveable within the outer vessel between an upper position and a lower position, preferably while the elevation of the substrate remains fixed. In another alternative embodiment, the inner vessel may be slidable within an opening in the outer vessel, rather than being collapsible within the outer vessel.

If desired, the system may be provided with megasonic transducers positioned to create a band of megasonic energy within the process chamber when activated. This band of energy serves as an active zone within the inner vessel to enhance the cleaning, rinsing and/or drying process as described in detail in WO03050861 APPARATUS AND METHOD FOR SINGLE- OR DOUBLE- SUBSTRATE PROCESSING, which is incorporated herein by reference.

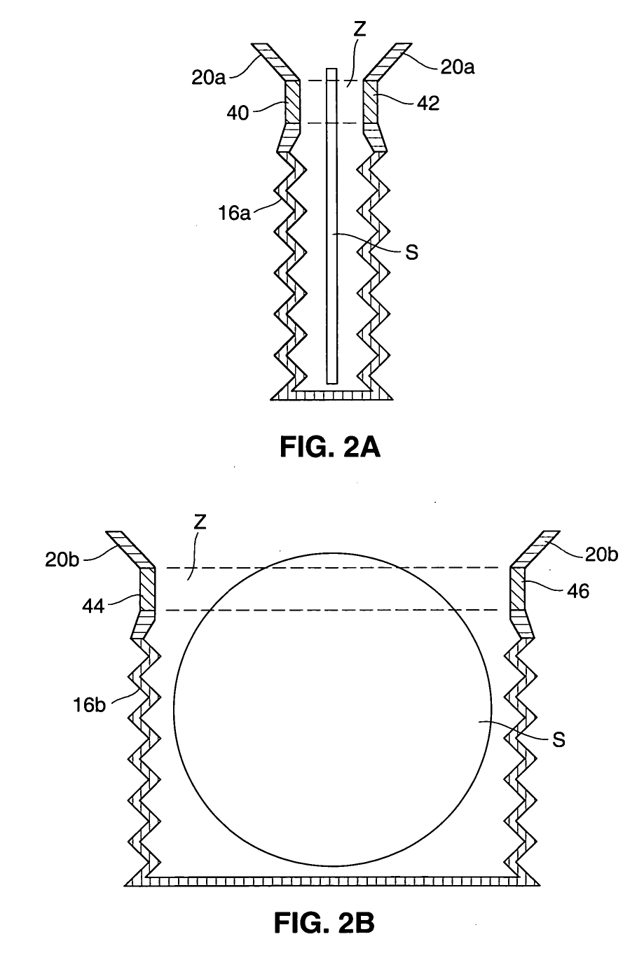

Inner vessels that may be similar to the inner vessel 16 of FIG. 1A but that are enhanced by megasonic capability are illustrated in FIGS. 2A and 2B. These inner vessels may be used in place of the inner vessel 16 of the type shown in FIG. 1A where megasonic capability is desired.

FIG. 2A illustrates a collapsible inner vessel 16a which is proportioned for single-wafer processing and which includes a pair of megasonic transducers 40, 42 coupled to the sidewalls of the inner vessel 16a. Each transducer 40, 42 may include a single transducer element or an array of multiple transducers. Transducers 40, 42 are positioned at an elevation below that of the upper edge 20a of the inner vessel 16a and are oriented such that transducer 40 directs megasonic energy towards the front surface of a substrate, while transducer 42 directs megasonic energy towards the back side of the substrate.

In the FIG. 2A embodiment, the transducers are preferably positioned such that the energy beam interacts with the substrate surface at or just below the gas/liquid interface, e.g. at a level within the top 0-20% of the liquid in the inner vessel 16a. The transducers may be configured to direct megasonic energy in a direction normal to the substrate surface or at an angle from normal. Preferably, energy is directed at an angle of approximately 0-30 degrees from normal, and most preferably approximately 5-30 degrees from normal.

It may be desirable to provide the transducers 40, 42 to be independently adjustable in terms of angle relative to normal and/or power. For example, if angled megasonic energy is directed by transducer 40 towards the substrate front surface, it may be desirable to have the energy from transducer 42 propagate towards the back surface at a direction normal to the substrate surface. Doing so can reduce or prevent or reduce breakage of features on the front surface by countering the forces imparted against the front surface by the angled energy. Moreover, while a relatively lower power or no power may be desirable against the substrate front surface so as to avoid damage to fine features, a higher power may be transmitted against the back surface (at an angle or in a direction normal to the substrate). The higher power can resonate through the substrate and enhance microcavitation in the trenches on the substrate front—thereby helping to flush impurities from the trench cavities.

Additionally, providing the transducers 40, 42 to have an adjustable angle permits the angle to be changed depending on the nature of the substrate (e.g. fine features) and also depending on the process step being carried out. In some instances it may also be desirable to have a single transducer, or more than two transducers, rather than the pair of transducers 40, 42.

FIG. 2B illustrates yet another alternative inner vessel 16b similar to the inner vessel of FIG. 2A but modified for use in a batch system such as the system illustrated in FIG. 1A. In the FIG. 2B embodiment, the transducers 44, 46 are preferably oriented facing the edges of the substrates S as shown, thus allowing megasonic energy emitted by the transducers 44, 46 to pass between adjacent substrates. The transducers may be configured to direct megasonic energy in a direction normal to the substrate surface or at an angle from normal. Preferably, energy is directed at an angle of approximately 0-10 degrees from normal, and most preferably approximately 1-3 degrees from normal.

Referring again to FIG. 1A, the system includes a fluid inlet 22 which directs process fluid such as DI rinse water into the inner vessel 16. A first drain 24 extends from inner vessel 16 and is preferably capable of allowing rapid (e.g. 15 cm/sec or faster) evacuation of fluid from the inner vessel, such as in performance of a quick dump. If desired, first drain 24 may alternatively permit slower and/or more controlled draining of the inner vessel.

A second valve 26 allows fluid in the outer vessel to be drained at a controlled rate (e.g. in the range of 0.5 mm/sec to 10 mm/sec).

A vapor/gas port 28 is fluidly coupled to the lid 12. Lid 12 includes manifolding configured to optimize even distribution of gas/vapor into the chamber 10.

An exhaust vent 30 extends from the chamber 10, preferably slightly below (e.g. approximately 1 mm below) the lid 12. The exhaust vent 30 is preferably immersed in a container 32 of liquid to as to prevent external air from passing through the vent into the chamber.

The inner vessel 16 of the batch system shown in FIG. 1A is preferably equipped to received a process cassette 36 holding one or more substrates. A lift 34 is preferably positioned within the inner vessel 16. Lift 34 includes automation (not shown) that moves the lift between lower and upper positions, thereby allowing the lift to slightly elevate substrates from a process cassette during operation. Because the first and last substrates in a substrate array can be exposed to slightly different process conditions than substrates in the middle of an array, the lift 34 may include “dummy substrates” (not shown) at opposite ends of the lift, so that the actual substrates positioned between the dummy substrates will be exposed to uniform process conditions. If desired, the lift may be configured to allow a charge to be applied to one of the dummy substrates so as to draw particles away from the other substrates in the array.

It will be appreciated that alternative systems may employ “cassette-less” transfer systems that transfer the one or more substrates, but not a process cassette, into the inner vessel 16. As one example, separation of the substrate(s) from the cassette may employ a passive lift system of a type well known in the art for removing substrates from a cassette for processing. As another example described in detail in WO03050861 APPARATUS AND METHOD FOR SINGLE- OR DOUBLE-SUBSTRATE PROCESSING, in a cassette-less system substrate(s) may be supported within the inner vessel by an end effector extending into the inner vessel and/or by a retention system provided within the inner vessel.

Operation

Use of the system of FIGS. 1A-1C to rinse and dry substrates will next be described.

First, one or more substrates S is lowered into inner vessel 16. The lid 12 is closed to enclose the substrates within the chamber. Process fluid such as DI rinse water is directed into the inner vessel 16 via inlet 22 and cascades over the edges 20 into the outer vessel 14. Drain 26 is opened to allow rinse fluid to drain from outer vessel 14 at a controlled rate. Flow of process fluid is preferably initiated before the substrates are moved into the chamber 10 to minimize exposure of the substrates to the air, however flow may alternatively be initiated during or after positioning of the substrates within the chamber.

If the system is one that uses a process cassette 36, the lift 34 is moved slightly upwardly to elevate the substrate(s) S from the process cassette. Although this step is optional, it is desirable to separate the substrate(s) from the cassette to prevent water accumulation at contact points during drying. As another alternative, the substrate(s) could be separated from the cassette prior to or during insertion as discussed earlier.

As discussed, performance of the system is enhanced by minimizing the amount of oxygen that can diffuse from the surrounding air into the process fluid. Thus, while the substrates are fully immersed in process fluid, an air displacement step may be performed to eliminate air from the chamber 10. According to this step, vent 30 is opened and a displacement gas (e.g. as nitrogen or argon or other inert gases) is introduced into the chamber 10 via inlet 28 to drive air out of the gap G between the lid 12 and the upper surface U of the cascading process fluid. The air is displaced out of the chamber 10 via the vent 30. In one embodiment, the displacement step may include a first step in which argon is used as the displacement gas and a second step in which nitrogen is used as the displacement gas. Using argon can shorten the overall duration of the displacement step, since heavier argon molecules can flush oxygen gas out of the gap G more quickly than lighter nitrogen molecules can. Although argon could be used throughout the displacement step, this two-step process may be desirable since N₂ is much lower in cost than argon. In another embodiment, a slight vacuum may be applied through vent 30 to assist in the removal of oxygen from gap G prior to introduction of the displacement gas.

If further rinsing is desired, a low flow of inert gas such as nitrogen and argon may continue until it is time for the IPA drying step.

The drying step is next performed, preferably at a chamber pressure of approximately Atm to Atm+5 in H₂O. To dry the substrates, a mixture of drying vapor (such as IPA) and carrier gas (such as nitrogen gas) are introduced into the chamber via port 28. IPA vapor generation is carried out in a separate IPA vapor generation chamber (not shown) prior to the moment at which the wafers are ready for drying. The IPA vapor may be formed using conventional methods, such as by bubbling nitrogen gas through a volume of liquid IPA. In another embodiment, IPA vapor may be created within the IPA vapor generation chamber by injecting a pre-measured quantity of IPA liquid onto a heated surface. According to this second embodiment, the IPA is heated to a temperature preferably less than the boiling point of IPA (which is 82.4° C. at 1 atmosphere) to create a dense IPA vapor cloud. When it is time to introduce the IPA vapor into the chamber 10 to dry the substrates, heated N₂ gas (having a temperature of approximately 70-120 C.) is passed into the IPA generation chamber and allowed to carry the IPA from the IPA generation chamber through the port 28 into the chamber 10. The manifold arrangement in the lid 12 promotes even distribution of IPA vapor through the channels in the lid and consequently an even flow of vapor through the inlets and onto the substrates.

The IPA and nitrogen utilized in the process are preferably high purity, such as “ppb” or parts per billion quality or 99.999% pure. The N₂/IPA preferably flows into the chamber at a rate of approximately 50 standard liters per minute (slpm) for an IPA drying period preferably 5-10 minutes. It is desirable to maintain a constant percentage of IPA in the N₂/IPA mixture. The percentage to be used will vary depending upon the surfaces being dried. By way of example, an N₂/IPA mixture having approximately 20-40% IPA vapor may be useful for a hydrophilic surface, whereas approximately 2-10% IPA vapor may be useful for a hydrophobic surface.

Fresh rinse fluid continues to flow into the inner vessel 16 and cascade over the edges 20 into the outer vessel 14 throughout the IPA drying step. As the N₂/IPA flows into the chamber, the inner vessel 16 is slowly collapsed, causing its upper edges 20 (and thus the cascading liquid level) to be slowly lowered at a uniform rate within the outer vessel 14. Preferably, the inner vessel 16 is collapsed at a rate that will cause the upper edges 20 (and thus the cascade level of the cascading liquid) to descend at a rate of approximately 0.5-10 mm/sec and most preferably at a rate of 1-2 mm/sec. It is desirable to ensure that the inner vessel 16 is collapsed smoothly so as to prevent splashing or level surges at the liquid/gas interface, since such splashing could re-wet dry areas of the substrates.

Throughout the IPA drying step, the cascade level drops along the surfaces of the substrates. Fresh rinse fluid continues to flow into the inner vessel 16 and to cascade over the edges 20 into outer vessel 14—thereby preventing accumulation of dissolved IPA and/or particles at the surface of the rinse fluid. The rate at which the fluid is drained from outer vessel 14 through drain 26 is controlled to keep the fluid level in the outer vessel below the level of the edges 20, and also to prevent the outer vessel from being drained completely. Complete emptying of the outer vessel (or even emptying to a point where the liquid level is lower than a predetermined level, which in a preferred method may be approximately 2 cm) is undesirable since it could lead to entry of air into the chamber 10 through the exposed drain 26.

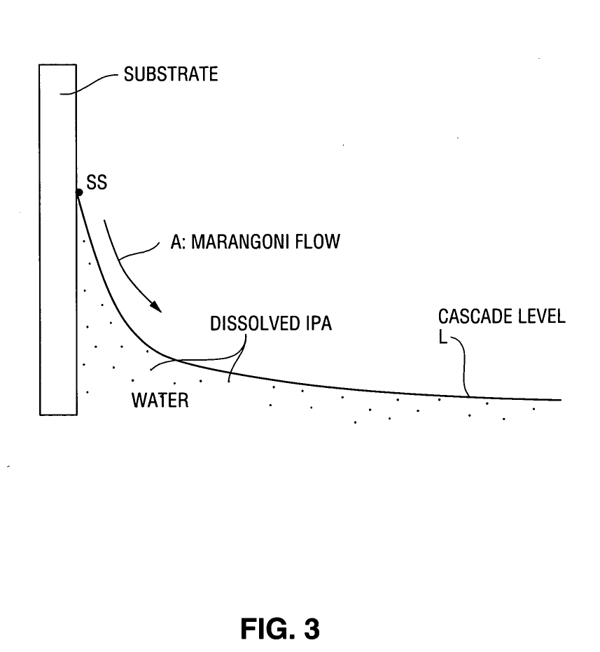

FIG. 3 schematically illustrates drying of a substrate S during the drying step just described. Referring to FIG. 3, as the cascade level L descends along the faces of the substrate during IPA vapor introduction, a fluid meniscus extends between the substrates and the bulk fluid in the inner vessel. The introduced IPA vapor dissolves into this fluid meniscus. As indicated in FIG. 3, the concentration of dissolved IPA vapor is highest at the substrates surfaces SS and lower at regions of the rinse fluid that are spaced from the wafer surfaces. Because surface tension decreases as IPA concentration increases, the surface tension of the water is lowest at the substrate surface where the IPA concentration is highest. The concentration gradient thus results in “Marangoni flow” of the rinse water away from the surfaces of the substrates as indicated by arrow A. Rinse water is thereby stripped from the wafer surfaces, leaving the wafer surfaces dry.

Referring to FIG. 1C, once the edges 20 of inner vessel 16 have descended to a predetermined elevation (e.g. to a point below the substrates or to at least the exclusion zone at the bottoms of the substrates), a final step is performed in which hot inert gas (e.g. nitrogen) having a temperature in the range of 50-100 C. is passed into chamber 10 via inlet 28. The heated gas removes any remaining rinse fluid and IPA vapor from the substrates and the cassette, and drives the IPA vapor from the environment of the chamber.

If the substrate(s) are processed using a system equipped to form a band of megasonic energy within the inner vessel, an alternative drying method may be performed. This method will be described in connection with a single wafer system employing the inner vessel 16a of FIG. 2A, but is equally suitable to batch systems including those having the inner vessel 16b of FIG. 2B.

Referring to FIG. 2A, as with the drying method described above, the cascade level is dropped across the surface of the substrate S during IPA introduction by lowering the upper edges 20a of inner vessel 16a and by simultaneously draining fluid from the outer vessel 14 (vessel 14 is shown in FIG. 1A). To enhance drying, megasonic transducers 40, 42 (FIG. 2A) are energized while the cascade level is dropped so as to create turbulence in the megasonic energy band or zone Z within the inner vessel 16a. This turbulence thins the boundary layer of fluid attached to the substrate. With the boundary layer thinned in zone Z, IPA can diffuse more quickly onto the surface and into the features of the substrate, thus leading to faster drying with reduced IPA usage. Because the zone Z descends along the surface of the substrate as the upper edges 20a are lowered, the substrate may be exposed to the IPA atmosphere relatively quickly (i.e. preferably at a rate of 30 mm/sec or less, and most preferably at a rate of between approximately 5 mm/sec-30 mm/sec), although relatively slower extraction rates such as those discussed above may also be used.

As with the previously described drying method, gas such as heated nitrogen may be introduced to evaporate any remaining IPA and/or water film, and the substrate and to drive the IPA vapor from the chamber.

Other alternative drying steps may be performed using the disclosed systems. In one such alternative drying step, flow of rinse fluid into the vessel is terminated and the fluid in the inner vessel is rapidly evacuated to a predetermined elevation (e.g. completely, or to a point below the elevation of the substrates or to at least the exclusion zone at the bottoms of the substrates) by performing a “quick dump” through valve 24. Once the liquid in the vessel has been discharged to a level below the wafers, nitrogen gas and IPA are caused to flow from the generation chamber through the port 28 into the chamber 10.

The IPA vapor condenses on the wafers, forming a uniform concentration of IPA in the liquid adhering to the wafer surface. The condensed IPA breaks the surface tension of water on the wafers and causes the rinse water to shear off of the wafer surfaces. By the end of the IPA drying period, the rinse water will have been completely removed from the waters, cassette, and vessel walls, and will have been replaced by a layer of condensed IPA.

The quick dump and IPA vapor steps of the alternative drying step provide several advantages over the prior art. One advantage provided over conventional vapor dryers is that the wafers remain in a purged environment throughout the entire process, rather than being exposed to oxygen and particles as they are moved from a rinse vessel to a drying vessel. Moreover, after the quick dump is performed, a carry over layer of water remains on the wafer surface. When IPA vapor begins to enter the chamber, it condenses on the surface of this carryover layer and diffuses into the water layer. As more IPA condenses on the water, it gradually decreases the surface tension of the water until the water eventually falls from the wafer surface. IPA vapor continues to enter the chamber and condenses on the wafer surface, leaving a layer of condensed IPA on the wafer surface.

This method of water removal is particularly beneficial for wafers having high aspect ratios or severe topography, where many tight spaces exist within the wafer surface. Capillary forces are high in such tight spaces and it is thus difficult to remove water from them. The method of condensing IPA onto the carry over layer of water where it can work its way into the water and then into the wafer's tight geometries (and continuing to condense onto the wafer surface after the carryover layer has fallen from the wafer) facilitates drying even in those deeply or tightly-patterned regions.

Moreover, the flow of condensed water and condensed IPA from the wafer surfaces promotes IPA/water rinsing of the wafer surfaces which facilitates removal of any particles that may remain on the wafers.

Another advantage lies in that the quick dump step is performed so as to completely evacuate the inner vessel (or at least to drain fluid in the vessel to below the wafers) in a very short period of time, preferably under five seconds. This high velocity draining of the liquid is beneficial to stripping water (and any particles in the water) off the surfaces of the wafers. It thus facilitates water removal even before the IPA vapor step is initiated.

The system described herein is thus advantageous in that it allows the user to select the mode of drying (e.g. the first-described mode in which the cascade level is lowered relative to the substrate or the quick-dump mode or, where available, the megasonic-assisted drying mode) to be carried out depending on the characteristics of the substrates or the nature of the process being performed.

Certain embodiments utilizing principles of the present invention have been described. These embodiments are given only by way of example and are not intended to limit the scope of the claims—as the apparatus and method of the present invention may be configured and performed in many ways besides those specifically described herein. For example, the system may be used to practice etching, cleaning and rinsing methods for which it may be desirable to move a cascade level across the surface of the substrate(s) (with or without the presence of a megasonic energy band), including those described in WO03050861 APPARATUS AND METHOD FOR SINGLE- OR DOUBLE-SUBSTRATE PROCESSING which is incorporated herein by reference. Moreover, numerous features have been described in connection with each of the described embodiments. It should be appreciated that the described features may be combined in various ways, and that features described with respect to one of the disclosed embodiments may likewise be included with the other embodiments without departing from the present invention. Finally, various dimensions, durations, process sequences, chemicals, volumes, etc. have been given by way of example and are not intended in a limiting sense.

1. A system for drying substrates, the system comprising:
a chamber;
an inner vessel positioned within the chamber, the inner vessel including at least one wall having an upper edge defining a cascade level, wherein the upper edge is retractable within the chamber from a first position in which the cascade level is at a first elevation to a second position in which the cascade level is at a second elevation.

2. The system according to claim 1, wherein the wall is collapsible to retract the upper edge from the first position to the second position.

3. The system according to claim 2, wherein the inner vessel has a first volume when then upper edge is in the first position, and a second volume when the upper edge is in the second position, and wherein the second volume is smaller than the first volume.

4. The system according to claim 1, wherein the inner vessel is moveable within the chamber from a first elevation to a second elevation to retract the upper edge.

5. The system according to claim 1, further including an fluid inlet fluidly coupled to the inner vessel for receiving a process fluid into the inner vessel.

6. The system according to claim 1, further including a gas inlet fluidly coupled to the chamber for directing a drying gas into the chamber.

7. The system according to claim 1, further including a lid moveable to a closed position enclosing the chamber.

8. The system according to claim 1, wherein the inner vessel is proportioned to receive a substrate carrier carrying at least one substrate, and wherein the system further includes a lift moveable within the chamber to elevate the substrate from the carrier.

9. The system according to claim 1, further including at least one megasonic transducer positioned to form a megasonic energy band across fluid in the inner vessel.

10. The system according to claim 9, wherein the megasonic transducer is positioned such that the megasonic energy band descends within the vessel during movement of the upper edge from the first position to the second position.

11. A method of treating a substrate, comprising the steps of:
providing a chamber and an inner vessel within the chamber, the inner vessel including an edge defining a cascade level;
positioning a wafer substrate in the inner vessel;
directing a process fluid into the inner vessel, causing the process fluid to flow over the edge;
during the directing step, lowering the edge within the chamber to thereby lower the cascade level.

12. The method of claim 11, wherein the lowering step includes collapsing at least a portion of the inner vessel.

13. The method of claim 12, wherein the collapsing step decreases the volume of the inner vessel.

14. The method of claim 11, wherein the lowering step includes lowering the inner vessel.

15. The method of claim 11, wherein the method is for rinsing and drying a substrate, wherein the directing step directs a rinse fluid, and wherein the method further includes passing a drying gas into the chamber during the lowering step and allowing the drying gas to contact fluid attached to the substrate above the cascade level.

16. The method of claim 15, wherein the drying gas reduces the surface tension of the fluid attached to the substrate above the cascade level.

17. The method of claim 16, wherein the drying gas induces Marangoni flow of the fluid attached to the substrate above the cascade level.

18. The method of claim 15, wherein the drying gas includes isopropyl alcohol.

19. The method of claim 11, wherein the chamber includes a vent, and wherein the method further includes the step of, prior to the lowering step, introducing a displacement gas into the chamber to purge oxygen out of the chamber through the vent.

20. The method of claim 11, wherein the introducing step includes introducing a first displacement gas comprising argon and then introducing a second displacement gas comprising nitrogen.

21. The method of claim 11, wherein the lowering step lowers the cascade level at a rate of between approximately 0.5-10 mm/sec.

22. The method of claim 11, wherein the lowering step lowers the cascade level at a rate of between approximately 1-2 mm/sec.

23. The method of claim 11, wherein the method includes the step of directing megasonic energy into the process fluid.

24. The method of claim 23, wherein the directing step forms a band of megasonic energy into the process fluid, and wherein the method further includes the step of lowering the band of megasonic energy relative to an elevation of the wafer substrate.

25. The method of claim 24, wherein the step of directing megasonic energy into the process fluid includes emitting megasonic energy from at least one megasonic transducer coupled to the edge, and wherein the step of lowering the edge causing the band of megasonic energy to lower relative to the elevation of the wafer substrate.

26. The method of claim 23, wherein the lowering step lowers the cascade level at a rate of approximately 30 mm/sec or less.

27. The method of claim 23, wherein the lowering step lowers the cascade level at a rate of between approximately 8-30 mm/sec.

28. The method of claim 11, wherein the directing and lowering steps are performed without withdrawing the wafer substrate from the chamber.
